(19) United States
(12) Patent Application Publication
(10) Pub. No.: US 2005/0170093 A1
(43) Pub. Date: Aug. 4, 2005

(54) Coating device and coating method

(75) Inventors: Gishi Chung, Nirasaki-shi (JP); Michio Tanaka, Kumamoto-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 10/502,797

(22) PCT Filed: Feb. 3, 2003
(86) PCT No.: PCT/JP03/01051

(30) Foreign Application Priority Data
Feb. 7, 2002 (JP) 2002-030829

(51) Int. Cl. B05D 5/00

(52) U.S. Cl. 427/256

(57) ABSTRACT

A coating apparatus (10) includes: a substrate holding section (16) which holds a substrate having a step on a major surface; a coating section (31) which applies a plurality of liquids different in viscosity from each other on a substrate; and a control section (70) which controls the coating section according to an arrangement of a step on the substrate. It is possible to effectively eliminate the steps of the substrate by applying the plural liquids different in viscosity according to the arrangement of the steps.

### TECHNICAL FIELD

The present invention relates to a coating apparatus and a coating method for coating a substrate with a liquid.

### BACKGROUND ART

In manufacturing a semiconductor device, the planarization or the like of an entire substrate is sometimes achieved by filling a recessed portion formed in the substrate such as a silicon wafer.

In order to thus planarize the entire substrate, for example, such a method is used in which a film with a certain thickness is formed on the substrate by coating, CVD, or the like, and thereafter, the film is polished by CMP (Chemical Mechanical Polishing) or the like. The planarization of the substrate is achieved by polishing the film formed on the substrate.

### DISCLOSURE OF THE INVENTION

Since this method includes the formation of the film and the polishing of the film, processes thereof tend to become complicated. Further, the use of extra film-forming materials is required since the film once formed is polished. This tends to increase labor and process cost required for the planarization, which has been a factor of obstructing cost reduction of manufacturing a semiconductor device.

The present invention was made in order to solve such a problem, and an object thereof is to provide a coating apparatus and a coating method capable of simplifying substrate planarization processes.

A. In order to achieve the object stated above, the coating apparatus according to the present invention includes: a substrate holding section which holds a substrate having a step on a major surface; a coating section which applies a plurality of liquids different in viscosity from each other on the substrate; and a control section which controls the coating section according to an arrangement of the step.

The plural liquids different in viscosity from each other are applied according to the arrangement of the step, so that the step of the substrate can be effectively eliminated.

The “arrangement of the step” mentioned here means the two-dimensional arrangement of the step relative to the major surface of the substrate, but may include the three-dimensional arrangement of the step including the depth of the step. In other words, the two-dimensional arrangement and the three-dimensional arrangement of the step may be both interpreted as the “arrangement of the step”.

(1) Here, one of the plural liquids may be a liquid that forms an insulative film or a conductive film when being dried.

Filling a bottom portion of the step with an insulative material or a conductive material makes it possible to appropriately form an insulation portion or a conductor portion on the substrate to form a circuit on the substrate.

(2) The coating section may be structured to be movable relatively to the substrate.

The movement of the coating section facilitates applying the liquids on a wide area of the substrate. Alternatively, it is also possible to fix the coating section and move the substrate.

(3) The coating section can have a plurality of discharge parts which discharge the plural liquids independently from each other.

Providing the discharge parts corresponding to the respective plural liquids facilitates switching among the liquids for coating.

Here, each of the plural discharge parts can have a plurality of discharge ports from which the liquids are discharged independently from each other.

Providing the plural discharge ports from which the liquids are discharged independently from each other facilitates controlling areas to be coated with the liquids.

(4) The plural discharge parts may be structured to be movable independently from each other.

The application of the plural liquids on different areas on the substrate can be facilitated.

(5) The control section may include a coated area determining part which determines areas to be coated on which the coating section is to apply the respective plural liquids.

The coated area determining part determines the areas to be coated, and coating is performed based on this determination, so that coating of appropriate areas can be facilitated.

Here, the coated area determining part may determine the area to be coated based on an inter-step interval or an inter-step area dimension in a bottom portion of the step (for example, in a manner such that a liquid with a high viscosity is applied on an area with a wide inter-step interval).

A swell of an applied planarizing solution from a substrate surface is closely correlated with the width of the step or the inter-step area dimension in the bottom portion of the step. Therefore, determining the area to be coated according to such a width or area dimension makes it possible to effectively eliminate the step of the substrate.

(6) The control section may control the coating section in terms of an application amount according to a depth and an interval of the step.

Changing the application amount according to the depth and interval of the step makes it possible to effectively eliminate the step.

(7) The coating apparatus may further include a drying section which dries the plural liquids.

Forcible drying of the liquids by the drying section can accelerate the drying of the liquids. This drying section may be either a local drying section which dries the liquid applied on the substrate locally or a total drying section which dries all the areas of the applied liquids at a time.

Here, the drying section may be divided into a plurality of drying parts corresponding to the respective plural liquids. Providing the drying parts corresponding to the respective plural liquids enables efficient drying.

The plural drying parts may be structured to be movable independently from each other, which can further improve efficiency of drying.

Further, the drying section may have either a heating part which heats the liquids or a pressure-reducing part which reduces a pressure of a vicinity of the substrate. Heating of the liquids, pressure reduction of the vicinity of the substrate, or the combination thereof can promote the drying of the liquids.

Incidentally, an example of the heating part can be a heating means that uses radiation or heat conduction of an infrared lamp, a heater, or the like.

(8) The coating apparatus may further include: a storage section which stores step arrangement information relating to the arrangement of the step; and an input section which inputs the step arrangement information to the storage section.

Storing the arrangement of the step can facilitate controlling the coating section according to the arrangement of the step.

Here, the input section may include: a two-dimensional arrangement information input part which inputs two-dimensional arrangement information representing a two-dimensional arrangement of the step; and a depth information input part which inputs depth information representing a depth of the step.

The three-dimensional arrangement of the step is divided into the two-dimensional arrangement information and the depth information when it is inputted, which can realize efficient input.

The two-dimensional arrangement information input part may include an image information acquiring portion which acquires image information of the substrate held by the holding section.

The image information acquiring portion acquires an image of the substrate held by the holding section, which enables accurate coating of the substrate even when the substrate is held by the holding section at a misaligned position.

B. A coating method according to the present invention includes: a first coating step of applying a first liquid on a substrate having a step on a major surface, according to an arrangement of the step; and a second coating step of applying, according to the arrangement of the step, a second liquid different in viscosity from the first liquid on the substrate on which the first liquid is applied in said first step.

Applying the liquids different in viscosity in sequence enables efficient elimination of the steps.

(1) Here, the first liquid may be higher in viscosity than the second liquid.

A liquid higher in viscosity is first applied to first eliminate a step with a larger bottom width, which enables efficient elimination of the steps.

(2) The coating method may further include a coated area determining step of determining areas to be coated on which the first and second liquids are to be applied in the first and second steps respectively.

Appropriate determination of the areas to be coated in the respective first and second coating steps enables efficient elimination of the steps.

(3) The coating method may further include, between the first and second coating steps, a drying step of drying the first liquid applied on the substrate in the first coating step.

Drying the first liquid prior to the second coating ensures an effect of eliminating the step by the first liquid to enable efficient elimination of the steps.

### BRIEF DESCRIPTION OF DRAWINGS

FIG. 1 is a rough cross-sectional view showing the entire configuration of a coating apparatus according to the present invention.

FIG. 2 is a rough plane view showing the entire configuration of the coating apparatus according to the present invention.

FIG. 3A to FIG. 3C are a perspective view, a front view, and a side view, respectively, showing in detail a planarizing solution discharge section and a drying section of the coating apparatus according to the present invention.

FIG. 4 is a flowchart showing an example of the procedure for planarizing a wafer by the coating apparatus according to the present invention.

FIG. 5(A) and FIG. 5(B) are a cross-sectional view and a schematic view showing steps on a wafer and an example of step arrangement information.

FIG. 6(A) and FIG. 6(B) are views showing a cross section of the wafer and an example of a discharge pattern of a planarizing solution during the procedure for planarizing the wafer by the coating apparatus according to the present invention.

FIG. 7(A) and FIG. 7(B) are views showing the cross section of the wafer and an example of a discharge pattern of a planarizing solution during the procedure for planarizing the wafer by the coating apparatus according to the present invention.

FIG. 8(A) and FIG. 8(B) are views showing the cross section of the wafer and an example of a discharge pattern of a planarizing solution during the procedure for planarizing the wafer by the coating apparatus according to the present invention.

FIG. 9 is a cross-sectional view showing the state in which a planarized layer is formed by applying a planarizing solution uniformly on the entire surface of the wafer and drying the planarizing solution.

FIG. 10 is a cross-sectional view showing an example of the state in which an area of the wafer is classified according to a reference value for the width of a recessed portion by image processing.

FIG. 11 is a cross-sectional view showing an example of the state in which an area of the wafer is classified according to the reference value for the width of the recessed portion by image processing.

FIG. 12 is a cross-sectional view showing an example of the state in which an area of the wafer is classified according to the reference value for the width of the recessed portion by image processing.

FIG. 13 is a cross-sectional view showing an example of the state in which an area of the wafer is classified according to the reference value for the width of the recessed portion by image processing.

FIG. 14 is a top view showing an example of a wafer having recessed portions formed therein.

FIG. 15 is a top view showing an example of areas to be coated on the wafer shown in FIG. 14.

FIG. 16 is a schematic view showing a coating apparatus according to a modification example of the present invention.

FIG. 17 is a schematic view showing a coating apparatus according to a modification example of the present invention.

FIG. 18 is a flowchart showing an example of the procedure for planarizing a wafer by the coating apparatus shown in FIG. 17.

FIG. 19 is a schematic view showing a coating apparatus according to a modification example of the present invention.

FIG. 20 is a schematic view showing a coating apparatus according to a modification example of the present invention.

### BEST MODE FOR CARRYING OUT THE INVENTION

### First Embodiment

Hereinafter, a coating apparatus 10 according to a first embodiment of the present invention will be described in detail with reference to the drawings.

The coating apparatus 10 applies planarizing solutions L1 to L3 different in viscosity to planarize steps formed on a substrate such as a wafer W.

The “step” here means a place with level difference on the substrate, for example, a boarder of a recessed portion on a substrate surface (or a border of a protruding portion on the substrate surface). This “step” includes a recessed portion formed on the wafer W by, for example, etching or the like as well as a protruding portion made by a structure (wiring, a gate electrode, an insulation film, or the like) formed on the wafer W, and any portion having level difference on the wafer W may be called a “step”.

The “planarization” means treatment in general for diminishing such a step, in other words, for leveling off the height.

A step between a lower place and a higher place can be eliminated in such a manner that the lower place is covered by the application of a planarizing solution and solidification of at least part of components thereof.

The planarizing solution may be any fluid at least part of whose components can be solidified after the application and which can cover the substrate, and may have either an insulative property or a conductive property when it is solidified. When it has an insulative property, the insulation between structures on the substrate can be ensured, and when it has a conductive property, it can be used as wiring, an electrode, or the like on the substrate.

The viscosity of the planarizing solution may be regulated by changing the components contained therein, or by changing a mixing ratio of the components contained therein. For example, when the planarizing solution is composed of a solute essentially composed of a solid component and a solvent dissolving the solute, the mixing ratio of the solute and the solvent is changed, so that the viscosity can be easily regulated.

The following a., b. show concrete examples of the planarizing solution.

a. Insulative Planarizing Solution

Examples of a planarizing solution that becomes insulative when solidified are a resist and a dielectric (SOD (Spin On Dielectric)).

An example of a resist material is a mixture of a substance used as a base (substantially corresponding to a solute) in which a photosensitive material is dissolved in cresol novolac resin, and n-butilacetate, methylamilketon, ethylrakutate or the like used as a solvent. An example of a typical SOD used for an oxide is a mixture of a polymerized polysilazane used as a solute portion and dibutyl ether or the like used as a solvent.

In these cases, the viscosity can be regulated by changing a ratio (concentration) of the solute and the solvent.

b. Conductive Planarizing Solution

Examples of a planarizing solution that becomes conductive when solidified are copper paste and silver paste. Each of these pastes is a mixture of a solute, which is composed of metal particulates (copper, silver), a binder binding the metal particulates together and so on, and a solvent such as xylene, and comes to have a conductive property when the solvent is vaporized so that the metal particulates contained in the solute are bound together by the binder.

(Entire Configuration of Coating Apparatus 10)

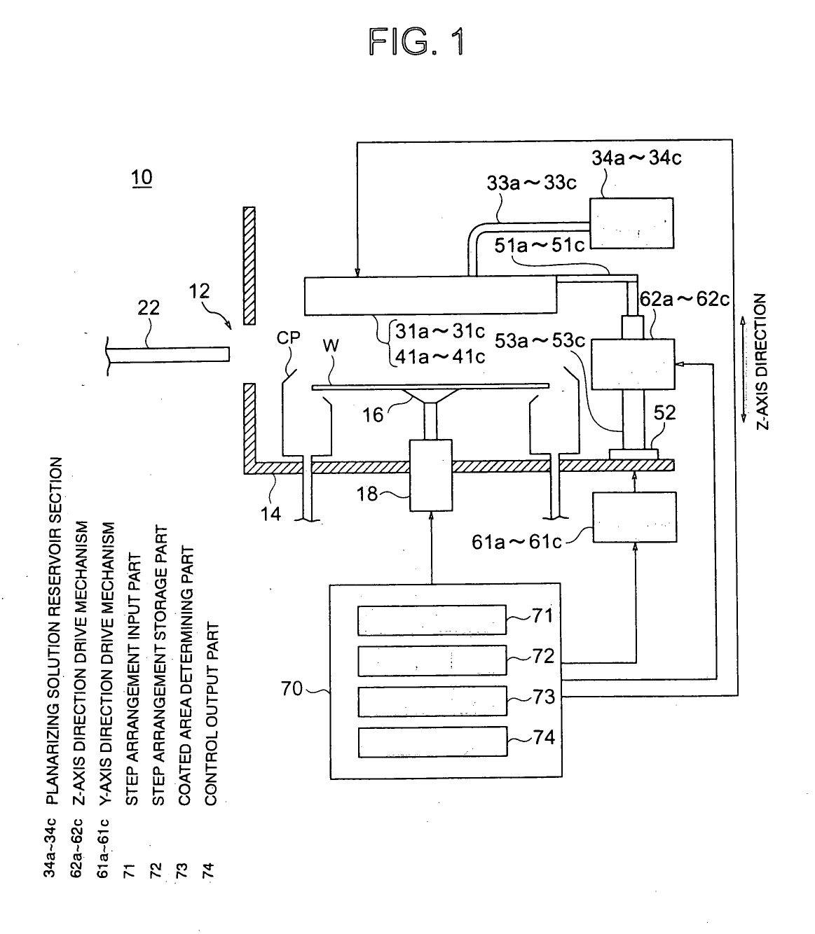

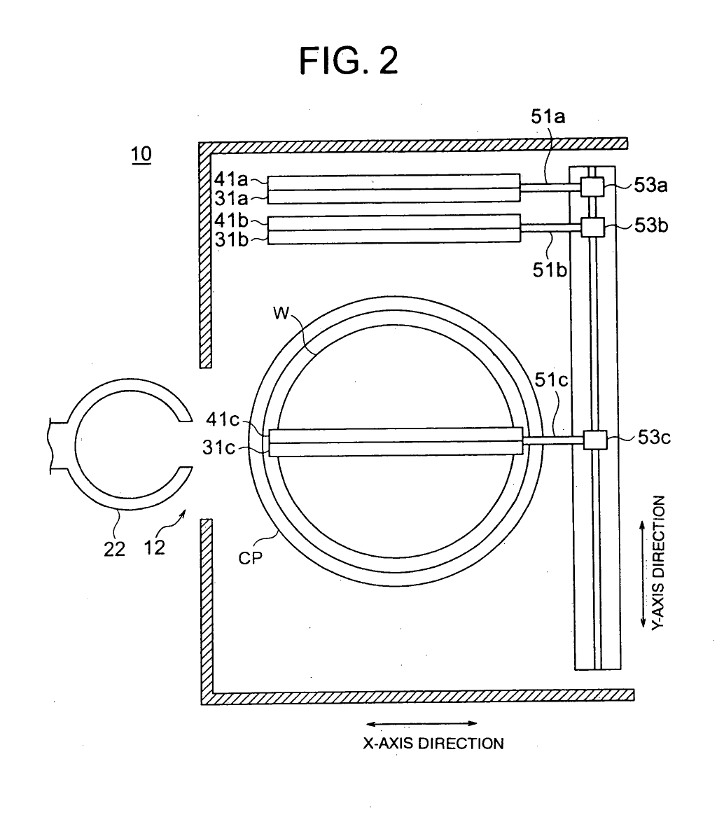

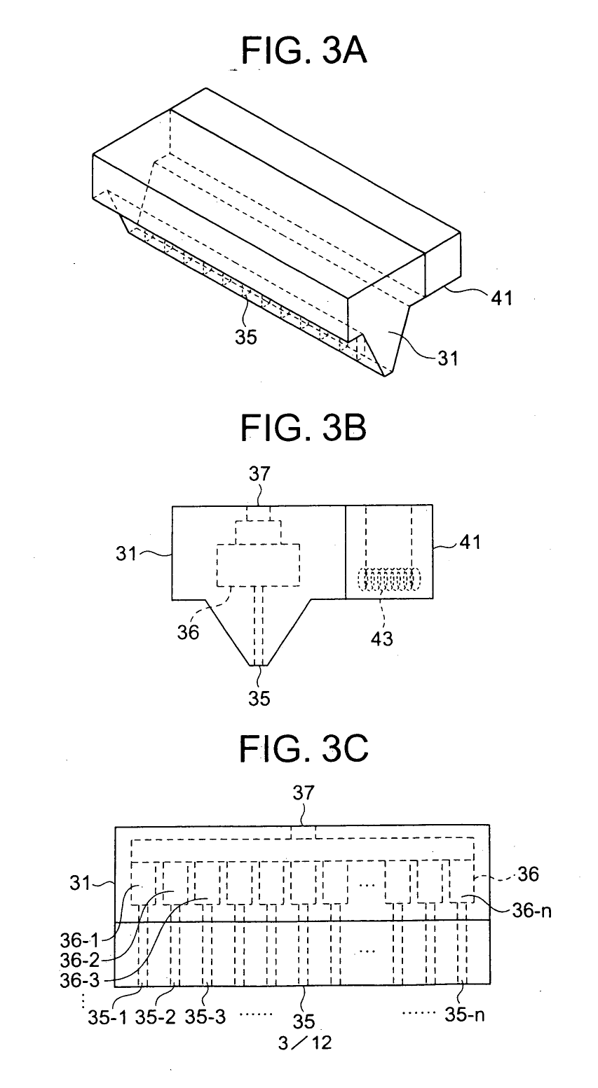

FIG. 1 and FIG. 2 are a rough cross-sectional view and a rough plane view showing the entire configuration of the coating apparatus 10. FIG. 3A to FIG. 3C are a perspective view, a front view, and a side view, respectively, showing in detail a planarizing solution discharge section 31 and a drying section 41 of the coating apparatus 10.

In a casing of the coating apparatus 10, a window 12 for having a wafer transfer member 22 holding a wafer W pass therethrough is formed to allow the carry-in and carry-out of the wafer W.

A ring-shaped cup CP is disposed on a unit bottom plate 14 in a center portion of the coating apparatus 10, and a chuck 16 is disposed inside the cup CP. The chuck 16 is intended for fixedly holding the wafer W by vacuum suction, and is coupled to a hoisting/lowering drive means 18 such as an air cylinder. When the wafer W is transferred between the wafer transfer member 22 and the chuck 16, the hoisting/lowering drive means 18 lifts the chuck 16 upward.

Using planarizing solution discharge sections 31a to 31c, the coating apparatus 10 applies planarizing solutions L1 to L3 different in viscosity respectively on the wafer W fixed to the chuck 16, thereby planarizing the wafer. W. Here, the discharge of the planarizing solutions L1 to L3 by the respective planarizing solution discharge sections 31a to 31c is controlled by a later-described control section 70.

Further, drying sections 41a to 41c dry the planarizing solutions L1 to L3 which are applied by the respective planarizing solution discharge sections 31a to 31c. The drying of the planarizing solutions L1 to L3 by the respective drying sections 41a to 41c is controlled by the control section 70.

(Details of Planarizing Solution Discharge Sections and so on)

The planarizing solution discharge sections 31a to 31c correspond to three kinds of the planarizing solutions L1 to L3 different in viscosity respectively, and the discharges thereof are independently controllable. The drying sections 41a to 41c are connected to the planarizing solution discharge sections 31a to 31c respectively. This means that the planarizing solution discharge sections 31a to 31c move as a unit with the drying sections 41a to 41c respectively.

Each of the planarizing solution discharge sections 31a to 31c is in a long plate shape and is arranged with its longitudinal direction being set horizontal, and they are connected to planarizing solution reservoir sections 34a to 34c via planarizing solution supply pipes 33a to 33c respectively. Note that the planarizing solution supply pipes 33a to 33c are connected to supply ports 35a to 35c of the planarizing solution discharge sections 31a to 31c.

The planarizing solution discharge sections 31a to 31c are detachably attached to tip portions of scan arms 51a to 51c respectively.

The scan arms 51a to 51c are attached respectively to upper end portions of vertical support members 53a to 53c that are horizontally movable on a guide rail 52 which extends in one direction (Y-axis direction) on the unit bottom plate 14, and are moved in the Y-axis direction as a unit with the vertical support members 53a to 53c by Y-axis direction drive mechanisms 61a to 61c.

The planarizing solution discharge sections 31a to 31c are also movable in an up and down direction (Z-axis direction) by Z-axis direction drive mechanisms 62a to 62c, respectively.

The planarizing solution discharge sections 31a to 31c have the discharge ports 35a to 35c and solution discharge control mechanisms 36a to 36c, respectively. The solution discharge control mechanisms 36a to 36c are connected to the discharge ports 35a to 35c respectively to regulate discharge amounts of the planarizing solutions from the discharge ports 35a to 35c independently from one another. Here, the solution discharge control mechanisms 36a to 36c are divided into individual solution discharge control mechanisms 36a-1 to 36a-n, 36b-1 to 36b-n, 36c-1 to 36c-n, respectively, and the discharge ports 35a to 35c are divided into discharge ports 35a-1 to 35a-n, 35b-1 to 35b-n, 35c-1 to 35c-n, respectively. The solution discharge control mechanisms 36-1 to 36-n are connected to the discharge ports 35-1 to 35-n respectively, and are capable of controlling the discharges of the planarizing solutions from the discharge ports 35-1 to 35-n independently from one another. Note that “n” is an arbitrary integer and is equal to the total number of the discharge ports 35-1 to 35-n.

At the time of coating, the planarizing solution discharge sections 31a to 31c are moved along the guide rail 52 by the Y-axis direction drive mechanisms 61a to 61c to scan the surface of the wafer W while the planarizing solutions L1 to L3 are discharged to the surface of the wafer W from the planarizing solution discharge sections 31a to 31c (the discharge ports 35a-1 to 35a-n, 35b-1 to 35b-n, 35c-1 to 35c-n) respectively.

Therefore, the movement of the planarizing solution discharge sections 31a to 31c by the Y-axis direction drive mechanisms 61a to 61c and the control over discharge amounts from the respective discharge ports 35a-1 to 35a-n, 35b-1 to 35b-n, 35c-1 to 35c-n are performed in conjunction with each other, so that the shape of an area on the wafer W supplied (coated) with the planarizing solutions and the thickness thereof can be controlled.

When the width of the planarizing solution discharged from each of the discharge ports 35-1 to 35-n is narrower than an interval between the discharge ports 35-1 to 35-n by a certain degree or more, there may be some cases where the planarizing solutions cannot be sufficiently applied on the wafer W only by one-time Y-axis direction scan by the planarizing solution discharge sections 31 (for example, uncoated portions occur in stripes). In this case, the X-axis direction movement of the planarizing solution discharge sections 31a to 31c concurrent with the Y-axis direction scan thereof makes it possible to apply the planarizing solutions on all the necessary portions. As an example, small reciprocal movement (for example, zigzag movement) in the X-axis direction of the planarizing solution discharge sections 31a to 31c is added at the time of the Y-axis direction scan thereof, so that the planarizing solutions can be applied on the entire surface of the wafer W.

Drying sections 41a to 41c respectively have lamps 43a to 43c emitting infrared lights, and the planarizing solutions L1 to L3 are heated and dried by radiant heat from the lamps 43a to 43c.

Since the drying sections 41a to 41c move as a unit with the planarizing solution discharge sections 31a to 31c respectively, the application of the planarizing solutions L1 to L3 is performed in parallel with the drying thereof.

The coating apparatus 10 has the control section 70 composed of a step arrangement input part 71, a step arrangement storage part 72, a coated area determining part 73, and a control output part 74.

The step arrangement input part 71 inputs step arrangement information.

The step arrangement information can be divided into two, namely, two-dimensional arrangement information representing two-dimensional (substrate surface direction: X-axis and Y-axis directions) arrangement of steps and depth information representing the relation between the two-dimensional arrangement information and the depths (substrate thickness direction: Y-axis direction) of the steps.

These two-dimensional arrangement information and the depth information may be inputted as a unit or may be inputted separately.

The “input” here includes not only inputting the arrangement of the steps as mere data but also measuring the arrangement of the steps of the wafer W to input the measurement data.

Further, the input of one of the two-dimensional arrangement information and the depth information may be the input as mere data and the input of the other information may be the input of the information including the measurement of the wafer W. For example, the step arrangement input part 71 may be constituted of the combination of a measuring portion (for example, a CCD camera) that measures the two-dimensional arrangement of the steps on the wafer W and a data input portion receiving the depth information of the steps of the wafer W.

The step arrangement storage part 72 stores the arrangement of the steps inputted (in some cases, measured) in the step arrangement input part 71.

The coated area determining part 73 determines the two-dimensional arrangement (areas to be coated) of the planarizing solutions L1 to L3 to be applied on the wafer W by the planarizing solution discharge sections 31a to 31c and determines the thickneses thereof based on the arrangement of the steps stored in the step arrangement storage part 72.

The control output part 74 outputs command information for driving the planarizing solution discharge sections 31a to 31c, the drying sections 41a to 41c, the Y-axis direction drive mechanisms 61a to 61c, and the Z-axis direction drive mechanisms 62a to 62C.

Therefore, when the planarizing solutions are applied on the wafer W, the discharge amounts of the planarizing solutions from the planarizing solution discharge sections 31a to 31c and the operation of the Y-axis direction drive mechanism 61 are both controlled in conjunction with each other according to the areas to be coated determined by the coated area determining part 73.

Further, the drying sections 41a to 41c dry the planarizing solutions L1 to L3 based on the command information from the control output part 74.

(Coating Treatment by Coating Apparatus 10)

Next, the coating treatment by the coating apparatus 10 as configured above will be described.

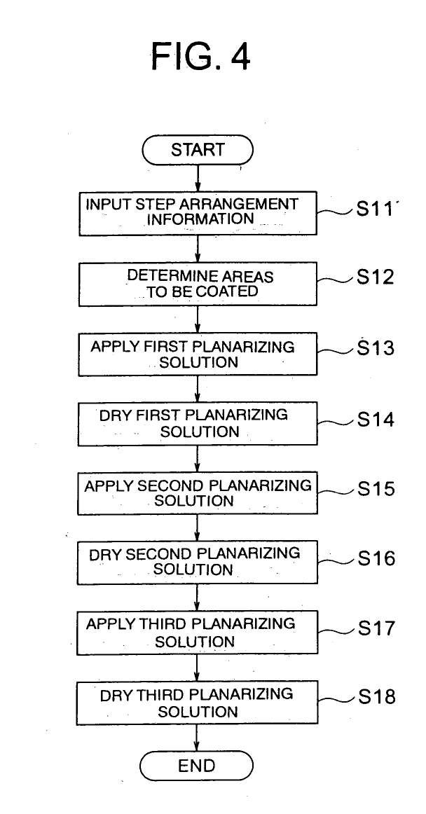

FIG. 4 is a flowchart showing the procedure for planarizing the wafer W by the coating apparatus 10.

(1) The step arrangement information of the wafer W is inputted (Step S11).

As described above, the step arrangement information is inputted via the step arrangement input part 71.

As previously described, the step arrangement information can be divided into the two-dimensional arrangement information representing the two-dimensional arrangement of the steps and the depth information representing the depths of the steps. These pieces of information may be inputted as a unit or may be inputted separately. For example, the depth information may be inputted as design information of a semiconductor element in advance, and the two-dimensional arrangement information may be inputted after the wafer W is held by the chuck 16. The two-dimensional arrangement information can be inputted in such a manner that, for example, two-dimensional image information of the wafer W is inputted via an imaging means such as a CCD and is subjected to image processing.

The inputting of the two-dimensional arrangement information based on the image information while the wafer W is being held makes it possible to cope with a misaligned held position of the wafer W.

When the two-dimensional arrangement information and the depth information are separately stored, information representing the correspondence relation therebetween is required. The correspondence information represents the correspondence relation between the two-dimensional positions of the steps (represented by the two-dimensional arrangement information) and the depths of the steps (represented by the depth information). Note that this information can be stored separately from one of or both of the two-dimensional arrangement information and the depth information.

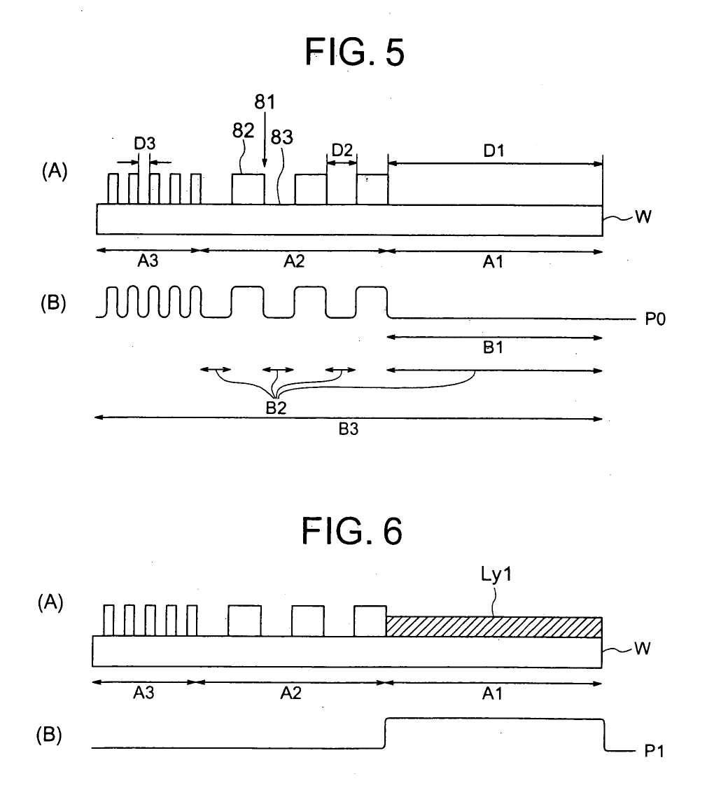

FIG. 5(A) and FIG. 5(B) are a cross-sectional view and a schematic view showing steps 81 on the wafer W and an example of the step arrangement information, respectively.

As shown in FIG. 5(A), the step 81 can be defined as a border between a protruding portion 82 (an upper portion of the step) and a recessed portion 83 (a bottom portion of the step) of the wafer W, and areas A1, A2, A3 in which widths D (D1, D2, D3) of the recessed portions 83 differ from one another exist in the wafer W. The areas A1, A2, A3 are results of dividing the wafer W to areas with three stages of widths D, for example, the width D equal to or more than a first reference value Dst1 (for example, 100 μm), the width D equal to or more than a second reference value Dst2 (for example, 20 μm) and less than the first reference value Dst1, and the width D less than the second reference value Dst2.

Step arrangement information P0 shown in FIG. 5(B) represents the arrangement of the steps of the wafer W shown in FIG. 5(A), and is a combination of part (Y-axis direction) of the two-dimensional arrangement information and the depth information (Z-axis direction) of the steps, thereby representing the arrangement of the steps in the Y-axis and Z-axis directions.

(2) Areas to be coated B1, B2, B3 on which the planarizing solutions L1 to L3 are to be applied respectively are determined based on the step arrangement information (Step S12).

This determination is made based on the widths D of the recessed portions 83. The determination of the areas to be coated B1, B2, B3 will be detailed later.

(3) Thereafter, the planarizing solutions L1 to L3 different in viscosity are applied in sequence according to the step arrangement information, and the planarizing solutions L1 to L3 are dried in parallel with the application of the respective planarizing solutions L1 to L3 (Steps S13 to S18, FIG. 6(A) to FIG. 8(B)).
a. First, the planarizing solution L1 with the highest viscosity is applied. Specifically, the planarizing solution discharge section 31a discharges the planarizing solution L1 while being moved by the Y-axis direction drive mechanism 61. At this time, the discharge/nondischarge and the discharge amount of the planarizing solution L1 from each of the discharge ports 35a-1 to 35a-n are controlled based on the step arrangement information. The application of the planarizing solution L1 eliminates the step in the area A1 of the wafer W.

The discharge/nondischarge of the planarizing solution L1 is controlled based mainly on the two-dimensional arrangement information, and the discharge amount at the time of the discharge is controlled based mainly on the depth information.

The planarization solution L1 is dried substantially in parallel with the application thereof. This drying is carried out in such a manner that the infrared light from the drying section 41a heats the surface of the planarizing solution L1 to vaporize the solvent of the planarizing solution L1.

By the application and drying of the planarizing solution L1, a planarized layer Ly1 is formed on the wafer W. A two-dimensional shape of the planarized layer Ly1 corresponds mainly to the two-dimensional arrangement information of the step 81, and the thickness of the planarized layer Ly1 corresponds mainly to the depth information of the step 81, so that the step of the wafer W is eliminated as a result.

FIG. 6(A) and FIG. 6(B) are a cross-sectional view and a schematic view showing the wafer W after the planarizing solution L1 is dried at Step S14 and a coating pattern of the planarizing solution L1 applied at Step S13, respectively. The planarized layer Ly1 is formed in the area A1 in which the width of the recessed portion 83 is equal to or more than a predetermined range.

In other words, the area to be coated B1 on which the planarizing solution L1 is to be applied matches the area A1 in this example.

b. Next, the planarizing solution L2 having a second highest viscosity is applied. Specifically, the planarizing solution discharge section 31b (the discharge ports 35b-1 to 35b-n) discharges the planarizing solution L2 while being moved by the Y-axis direction drive mechanism 61.

The discharge/nondischarge of the planarizing solution L2 is controlled based mainly on the two-dimensional arrangement information, and the discharge amount at the time of the discharge is controlled based mainly on the depth information. The reason why an application amount of the planarizing solution L2 on a place corresponding to the area A1 is made smaller than that in the area. A2 is that it is taken into consideration that a certain degree of elimination of the steps has been realized owing to a certain degree of planarization by the planarizing solution L1. If the planarization of the area A1 by the planarizing solution L1 is sufficient, there may be some case where no planarizing solution L2 is applied on the area A1. Thus, the application of the planarizing solution L2 is carried out in consideration of the degree of the planarization by the previously applied planarizing solution.

The applied planarizing solution L2 is dried substantially in parallel with the application of the planarizing solution L2.

A planarized layer Ly2 is formed on the wafer-W by the application and drying of the planarizing solution L2. The two-dimensional shape of the planarized layer Ly2 corresponds mainly to the two-dimensional arrangement information of the steps, and the thickness of the planarized layer Ly2 corresponds mainly to the depth information of the steps, so that the steps of the wafer W is eliminated as a result.

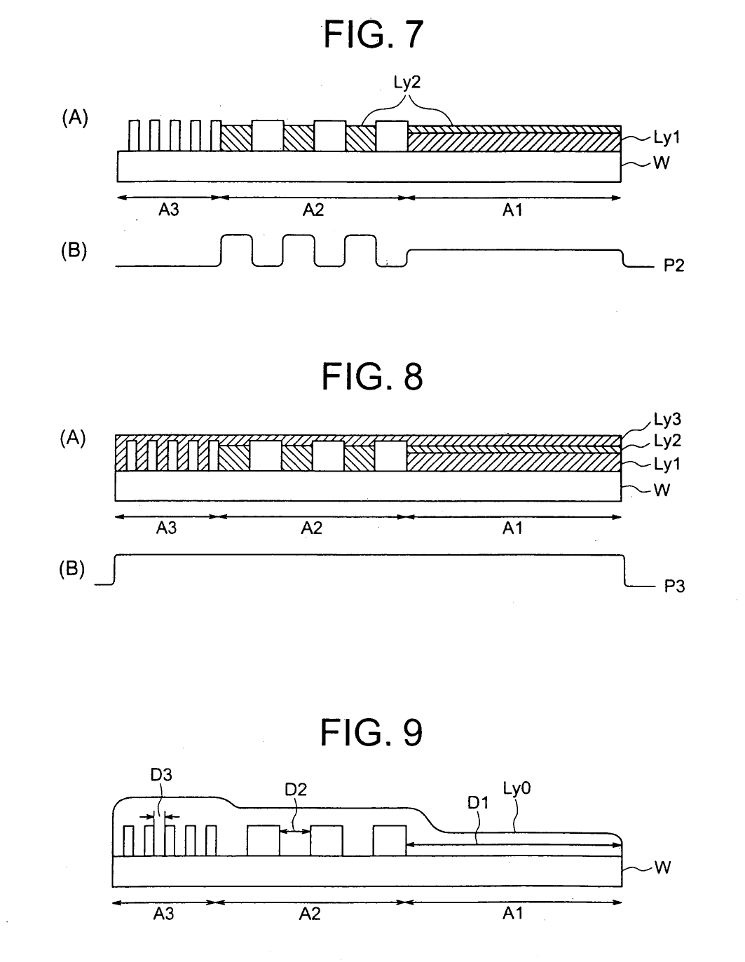

FIG. 7(A) and FIG. 7(B) are a cross-sectional view and a schematic view, respectively, showing the wafer W after the planarizing solution L2 is dried at Step S16 and a coating pattern of the planarizing solution L2 applied at Step S15. The planarized layer Ly2 is formed in the areas A1, A2 (the recessed portions 83 therein) in which the widths of the recessed portions 83 are equal to or more than the reference value Dst2.
c. The planarizing solution L3 having the lowest viscosity is further applied by the planarizing solution discharge section 31c and is dried by the drying section 41c, so that a planarized layer Ly 3 is formed.

FIG. 8(A) and FIG. 8(B) are a cross-sectional view and a schematic view, respectively, showing the wafer W after the planarizing solution L2 is dried at Step S18 and a coating pattern of the planarizing solution L3 applied at Step S17. A planarized layer Ly3 is formed on the areas A1, A2, A3 in which the widths of the recessed portions 83 are less than the reference value Dst2, namely, on the entire surface of the wafer W.

In other words, the area to be coated B3 on which the planarizing solution L3 is to be applied covers all of the areas A1, A2, A3 in this example.

As described above, the planarizing solutions L1, L2, L3 are applied and dried in sequence, so that the steps of the wafer W are gradually eliminated.

(Details of Determination of Areas to be Coated on which Planarizing Solutions are to be Applied)

The determination of the areas to be coated B1, B2, B3 on which the planarizing solutions L1, L2, L3 are to be applied respectively at Step S12 will be detailed below.

(1) The reason why the areas to be coated are set when the planarizing solutions L1, L2 are applied will be explained.

First, for easy understanding, it is assumed that a planarizing solution is applied uniformly on the entire surface of the wafer W.

FIG. 9 is a cross-sectional view showing the state in which a planarized layer Ly0 is formed by applying a planarizing solution L0 uniformly on the entire surface of the wafer W and drying the planarizing solution L0.

The wafer W is divided into three areas C1 to C3 in which the widths D of the recessed portions 83 are different from one another, and the surfaces thereof are covered with the planarized layer Ly0. The thickness of the planarized layer Ly0 seen from the recessed portions 83 of the wafer W differs among the respective areas C1 to C3, and as a result, it is understood that the planarization of the wafer W can be hardly considered sufficient.

In other words, there occurs incomplete elimination of the steps in relation to the arrangement of the steps.

The wider the width D of the recessed portion 83 is, the larger the necessary amount of the planarizing solution L0 is for filing the width D thereof. On the other hand, the narrower the width D of the recessed portion 83 is, the smaller the necessary amount of the planarizing solution L0 is for filling this.

Therefore, if the planarizing solution L0 is uniformly applied on the entire surface of the wafer W, the amount of the planarizing solution L0 is not sufficient for eliminating the step 81 in the step whose width D is wide (whose space volume is large), and is excessive for the step 81 whose width D is narrow (whose space volume is small), so that this portion becomes swollen.

From the above-described reason, it is understood that more preferably, the areas to be coated are set at the time of the application of the planarizing solutions, taking the arrangement of the steps on the wafer W into consideration.

(2) Next, the relation between the viscosity of the planarizing solutions L1 to L3 and the setting B1 to B3 of the areas to be coated will be explained.

The viscosity of the planarizing solution L0 is closely correlated with the spread of the area coated therewith, and the higher the viscosity is, the smaller the spread of the applied planarizing solution is. This means that more reliable application of the planarizing solution on a determined area is ensured as the viscosity thereof is higher. Thus, the use of the planarizing solution high in viscosity is preferable when it is desired to locally limit the area to be coated on which the planarizing solution is to be applied.

As shown in FIGS. 6(A), 6(B) to FIGS. 8(A), 8(B), the areas to be coated B1 to B3 on which the planarizing solutions L1 to L3 are to be applied becomes gradually wider so as to cover the area A1, the areas A1 and A2, and the areas A1 to A3 in a rough view. In more detailed view, the area to be coated B2 on which the planarizing solution L2 is to be applied is limited only to the recessed portions 83, but in a rough view, the planarizing solution L2 are applied on the areas A1 and A2.

From the above, it is understood that the dimension of the area to be coated is preferably made wider according to the viscosity of the planarizing solution.

(3) In the above-described manner, the areas to be coated B1 to B3 on which the planarizing solutions L1 to L3 are to be applied respectively are determined in conjunction with the arrangement of the steps (the widths of the recessed portions 83) and the viscosity of the planarizing solution L1 to L3.

A possible way for determining the correspondence relation is such that a planarizing solution with a first viscosity is applied on an area having a step whose width is equal to or larger than a first predetermined width, and a planarizing solution with a second viscosity that is higher than the first viscosity is applied on an area having a step whose width is equal to or larger than a second predetermined width that is larger than the first predetermined width. In this manner, a planarizing solution with a lower viscosity is applied on a wider area, and in addition, a step with a larger width is coated a plurality of times, which contributes to the elimination of the steps.

Also in FIGS. 6(A), 6(B) to FIGS. 8(A), 8(B) described previously, only the planarizing solution L3 low in viscosity is applied on the area A3 in which the width D is small, the planarizing solutions L2, L3 low and intermediate in viscosity are applied on the area A2 in which the width D is at an intermediate level, and the planarizing solutions L1 to L3 with three different low, intermediate, and high viscosities are applied on the area A1 in which the width is large.

Note that the coating of the areas A1, A2, A3 may be further limited since application amounts at this time are determined according to the depths of the steps.

(4) Concrete examples of the determination of the areas to be coated will be shown.

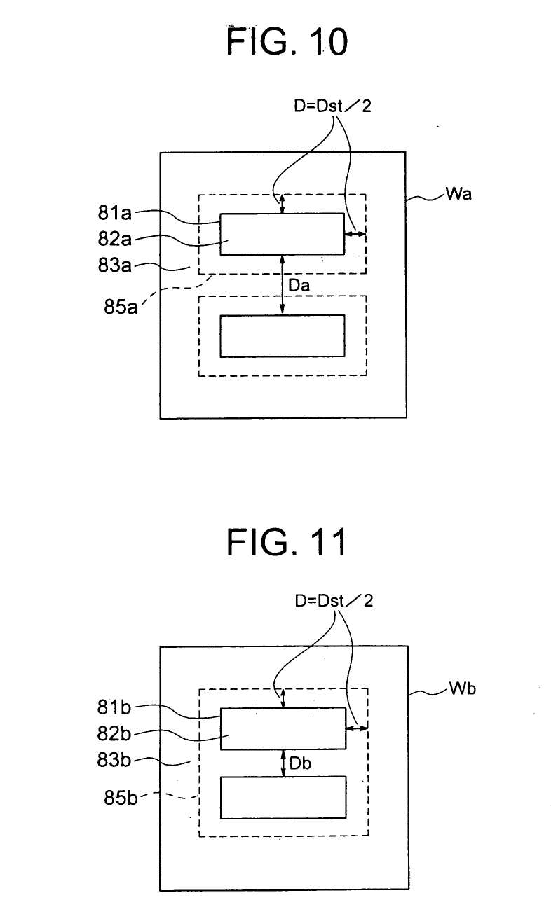

The areas to be coated can be easily demarcated by image processing.
a. FIG. 10 and FIG. 11 are cross-sectional views showing an example of how areas of the wafer W are classified according to the reference value Dst for the width of the recessed portion 83 by image processing.

Here, the areas of the wafer W are classified based on the contours (arrangement of the step) of protruding portions 82, resulting in the classification according to the width of the recessed portion 83.

In FIG. 10 and FIG. 11, protruding portions 82a, 82b and adjacent protruding portions 82a, 82b are adjacent to each other with intervals Da, Db therebetween, respectively. Areas 85a, 85b with the width D (D=Dst/2) are set around the protruding portions 82a, 82b.

At this time, since the interval Da in FIG. 10 is larger than the reference value Dst, the areas 85a are separated from each other, while, on the other hand, the area 85b is an integrated wide area since an interval Db in FIG. 11 is equal to or smaller than the reference value Dst. The areas with the width D (D=Dst/2) are thus formed around the protruding portions 82, and based on whether or not these areas are integrated, it is possible to determine whether or not each interval between the protruding portions 82a, 82b (in other words, the width of the recessed portion 83) is equal to or smaller than the reference value Dst.

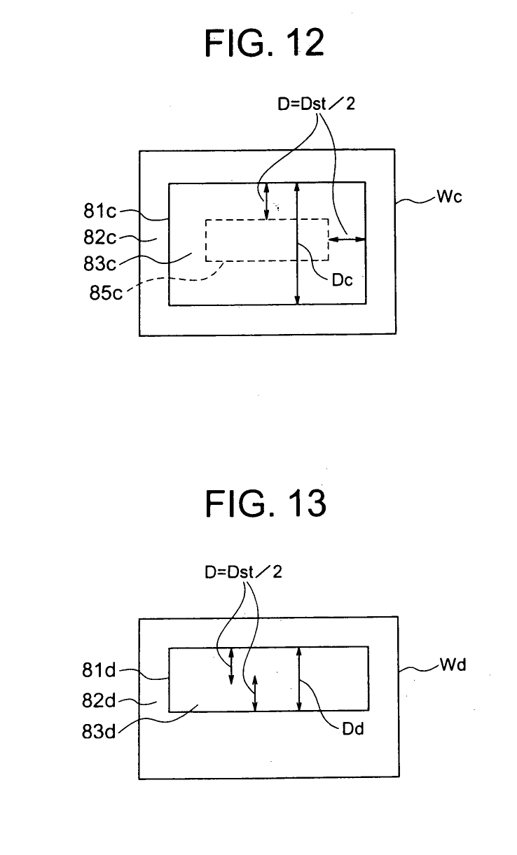

b. FIG. 12 and FIG. 13 are cross-sectional views showing another example of how areas of the wafer W are classified according to the reference value Dst for the width of the recessed portion 83 by image processing.

Here, the areas of the wafer W are classified based on the contours themselves of the recessed portions 83 (the arrangement of the step).

In FIG. 12 and FIG. 13, recessed portions 83c, 83d have widths Dc, Dd respectively. Areas 85c, 85d are set apart from the inner side of the recessed portions 83c, 83d by the width D (D=Dst/2).

At this time, the area 85c exists in FIG. 12 since the width Dc is larger than the reference value Dst, while the area 85d does not exist in FIG. 13 since the width Dd is equal to or less than the reference value Dst. In this manner, based on whether or not the area can be set apart from the inner side of the recessed portions 83c, 83d by the width D (D=Dst/2), it is possible to determine whether or not the width of the recessed portion 83 is equal to or less than the reference value Dst.
c. When the planarizing solutions L1, L2, L3 with high, intermediate, and low viscosities are applied on the areas to be coated B1, B2, B3 respectively as in the above-described embodiment, the areas to be coated B1, B2 can be determined through the use of the two different reference values Dst, namely, Dst1 and Dst 2 (Dst1>Dst 2). It is possible to determine the area to be coated B3 similarly to the areas to be coated B1, B2, but this determination is not necessary under the precondition that the planarizing solution L3 with the lowest viscosity is to be applied on the entire areas.

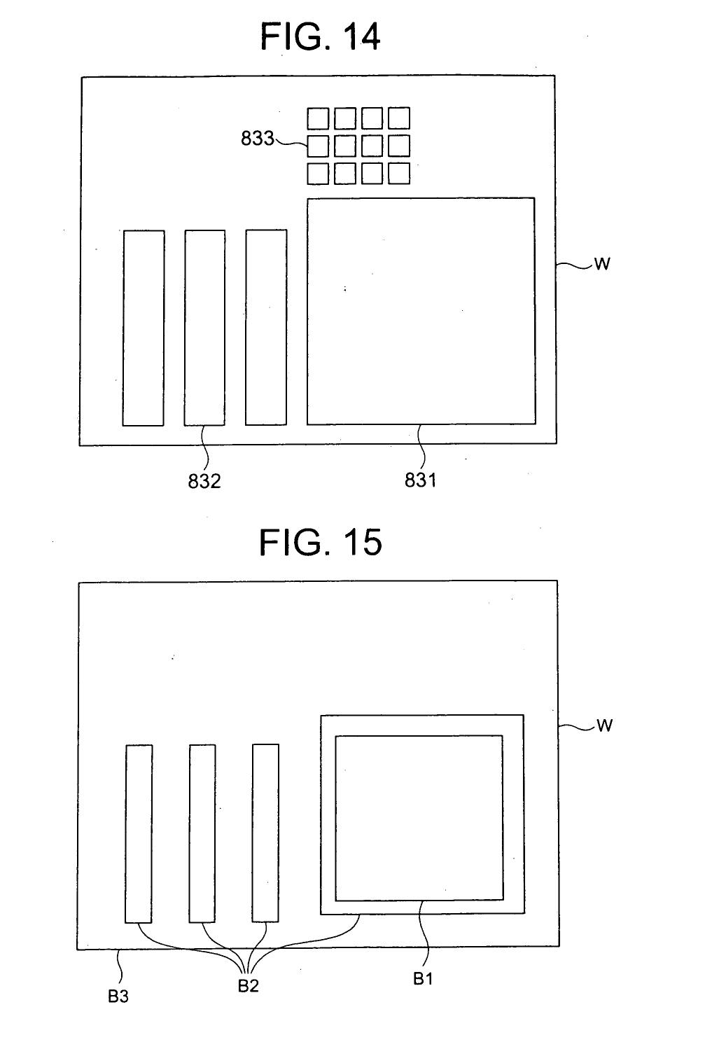

FIG. 14 and FIG. 15 are top views showing the wafer W having recessed portions 831, 832, 833 formed therein and an example of the areas to be coated B1 to B3, respectively.

Widths D1, D2 of the recessed portions 831, 832 are larger than the reference values Dst1 and Dst2 respectively, and a width D3 of each of the recessed portions 833 is smaller than a reference value Dst 3.

Accordingly, the areas to be coated B1, B2 are set inside the recessed portion 831, the areas to be coated B2 are set inside the recessed portions 832, and neither of the areas to be coated B1, B2 is set inside the recessed portions 833.

On the other hand, the area to be coated B3 is set to cover the entire area of the wafer W irrespective of any of the recessed portions 831 to 833.

### MODIFICATION EXAMPLE 1

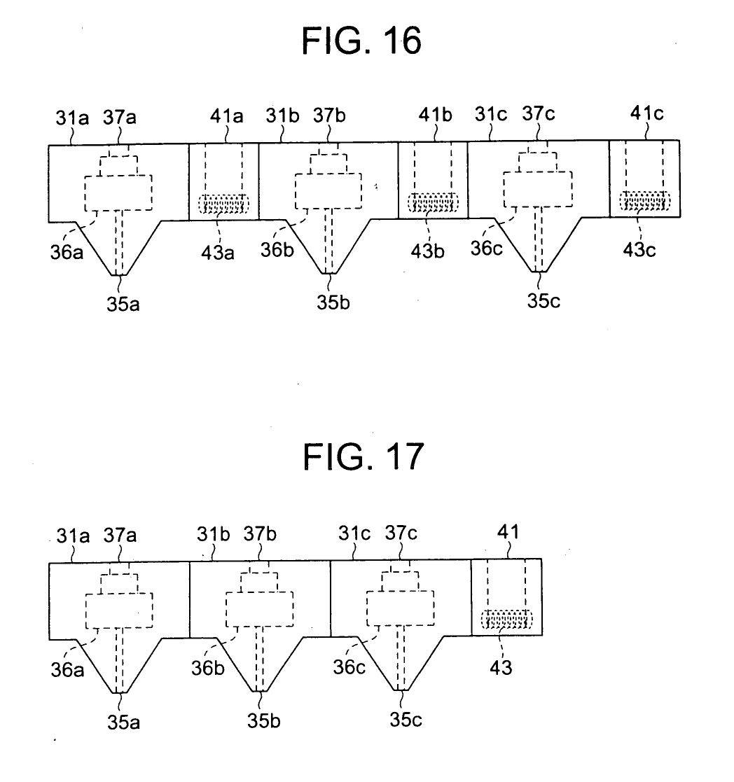

FIG. 16 is a schematic view showing a coating apparatus 10a according to a modification example 1 of the present invention.

As shown in FIG. 16, the coating apparatus 10a is structured such that planarizing solution discharge sections 31a to 31c and drying sections 41a to 41c are connected to each other to move as a unit. This structure allows the execution of the application and drying of the planarizing solutions L1, L2, L3 shown in FIG. 4 with one operation.

### MODIFICATION EXAMPLE 2

FIG. 17 is a schematic view showing a coating apparatus 10b according to a modification example 2 of the present invention.

As shown in FIG. 17, the coating apparatus 10b is structured such that planarizing solution discharge sections 31a to 31c and a drying section 41 are connected to each other to move as a unit. In other words, the three planarizing solution discharge sections 31 correspond to the single drying section 41.

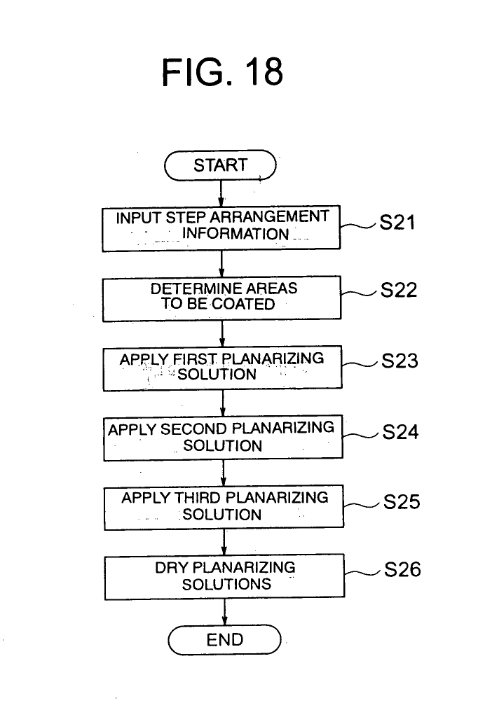

FIG. 18 is a flowchart showing the procedure for applying the planarizing solutions L1, L2, L3 on the wafer W by the coating apparatus 10b.

After the step arrangement information is inputted and the areas to be coated B1, B2, B3 are determined based on the inputted information (Steps S21, S22), the planarizing solutions L1, L2., L3 are applied, and thereafter the drying section 41 dries the planarizing solutions L1, L2, L3.

### MODIFICATION EXAMPLE 3

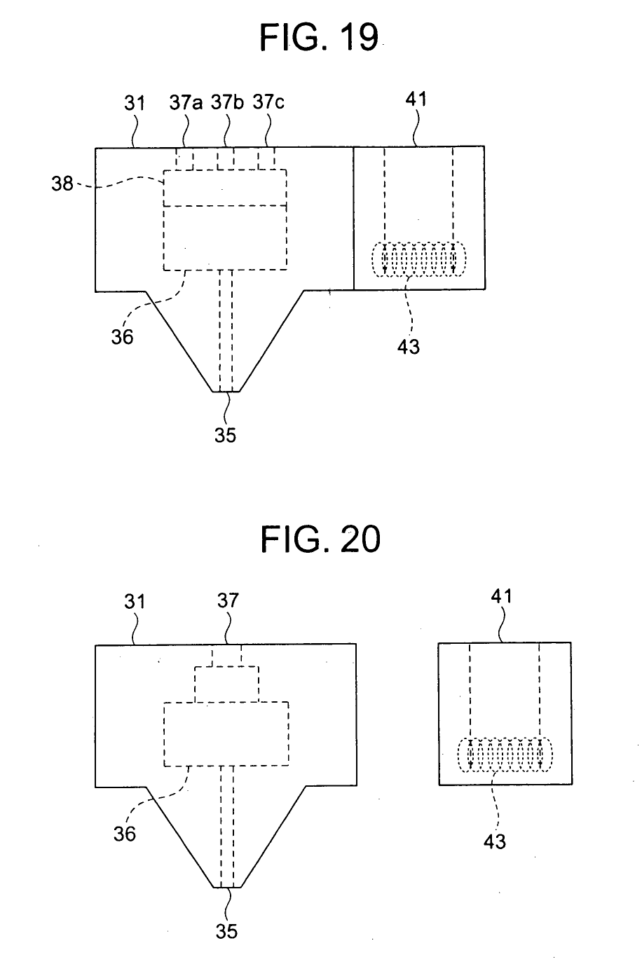

FIG. 19 is a schematic view showing a coating apparatus 10c according to a modification example 3 of the present invention.

As shown in FIG. 19, a planarizing solution discharge section 31d of the coating apparatus 10c has supply ports 37a to 37c to which the planarizing solutions L1 to L3 are supplied respectively, and a planarizing solution switching section 38 switches the planarizing solution to be supplied to a solution discharge control mechanism 36, among the planarizing solutions L1 to L3. By this switching, the planarizing solution to be discharged from a discharge port 35 can be switched among the planarizing solutions L1 to L3. In other words, in this coating apparatus 10c, the plural planarizing solutions L1 to L3 can be discharged by the single planarizing solution discharge section 31d.

### MODIFICATION EXAMPLE 4

FIG. 20 is a schematic view showing a coating apparatus 10d according to a modification example 4 of the present invention.

As shown in FIG. 20, a planarizing solution discharge section 31 of the coating apparatus 10c is separated from a drying section 41, so that they can move separately.

### Other Embodiments

The embodiment of the present invention is not limited to the above-described embodiment and may be expanded and changed. The expanded and changed embodiments are also included in the technical scope of the present invention.

(1) For example, in the above-described embodiment, a case where the substrate is a wafer is shown, but various materials such as glass, resin, and metal are usable for forming the substrate, or the substrate may be made of a complexed material of these plural materials. Further, the substrate may be varied in shape such as a polygon (for example, a regular tetragon or a rectangle) other than a circle. Concretely, the application to a panel for flat panel display (for example, a liquid crystal display device) and a printed board for printed wiring is possible.

(2) In the above-described embodiment, each of the planarizing solution discharge sections has the plural discharge ports whose discharge of the planarizing solutions can be independently controlled, but each of the planarizing solution discharge sections may have only one discharge port.

In the above-described embodiment, the plural discharge ports of the planarizing solution discharge section are arranged in a line, so that the entire surface of the wafer W can be coated only by the one-axis (Y-axis) direction movement of the planarizing solution discharge section. However, even if there is only one discharge port, the entire surface of the wafer W can be coated by the two-axis (X- and Y-axis) direction movement of the planarizing solution discharge section.

(3) The drying is not limited to drying by an infrared light of a lamp or a heater, but may be performed through pressure reduction or through the co-use of the pressure-reduction and the infrared light. The drying by the pressure reduction can be performed by setting the pressure in the vicinity of the wafer W to be lower than the atmospheric pressure. The pressure reduction promotes the evaporation of a solvent or the like of the planarizing solution. The pressure reduction can be performed by, for example, setting the wafer W in an airtight state and discharging the air by a vacuum pump or the like.

The coating and drying can be performed concurrently in parallel with each other. Such complete concurrent, parallel processing is enabled by, for example, the radiation of the entire wafer W with a lamp or pressure reduction of the vicinity of the wafer.

(4) In the above-described embodiment, the planarizing solution with a higher viscosity is applied first, but a planarizing solution with a lower viscosity may be applied first, or the application may be performed in a random order. The planarization of the wafer W is achieved when the viscosity of the applied planarizing solution is appropriate for the area to be coated.

Further, the applied planarizing solutions need not be limited to those of three kinds. They may be of two kinds or four kinds or more, or may be of only one kind. The main point is that the areas on which the planarizing solutions are applied should be appropriate for the arrangement of the steps.

### Industrial Applicability

The coating apparatus according to the present invention is capable of simplifying planarizing processes of a substrate, and can be industrially used and manufactured.

1. A coating apparatus, comprising:
a substrate holding section which holds a substrate having a step on a major surface;
a coating section which applies a plurality of liquids different in viscosity from each other on the substrate; and
a control section which controls said coating section according to an arrangement of the step.

2. The coating apparatus according to claim 1, wherein one of the plural liquids is a liquid that forms an insulative film when being dried.

3. The coating apparatus according to claim 1, wherein one of the plural liquids is a liquid that forms a conductive film when being dried.

4. The coating apparatus according to claim 1, wherein said coating section is movable relatively to the substrate.

5. The coating apparatus according to claim 1, wherein said coating section has a plurality of discharge parts which discharge the plural liquids independently from each other.

6. The coating apparatus according to claim 5, wherein each of said plural discharge parts has a plurality of discharge ports from which the liquids are discharged independently from each other.

7. The coating apparatus according to claim 5, wherein said plural discharge parts are movable independently from each other.

8. The coating apparatus according to claim 1, wherein said control section includes a coated area determining part which determines areas to be coated on which said coating section is to apply the respective plural liquids.

9. The coating apparatus according to claim 8, wherein said coated area determining part determines the area to be coated based on an inter-step interval or an inter-step area dimension in a bottom portion of the step.

10. The coating apparatus according to claim 9, wherein said coated area determining part determines the area to be coated in a manner such that a liquid with a high viscosity is applied on an area with a wide inter-step interval.

11. The coating apparatus according to claim 1, wherein said control section controls said coating section in terms of an application amount according to a depth and an interval of the step.

12. The coating apparatus according to claim 1, further comprising a drying section which dries the plural liquids.

13. The coating apparatus according to claim 12, wherein said drying section is divided into a plurality of drying parts corresponding to the respective plural liquids.

14. The coating apparatus according to claim 12, wherein said plural drying parts are movable independently from each other.

15. The coating apparatus according to claim 12, wherein said drying section has a heating part which heats the liquids.

16. The coating apparatus according to claim 12, wherein said drying section has a pressure-reducing part which reduces a pressure of a vicinity of the substrate.

17. The coating apparatus according to claim 1, further comprising:
a storage section which stores step arrangement information relating to the arrangement of the step; and
an input section which inputs the step arrangement information to the storage section.

18. The coating apparatus according to claim 17, wherein said input section comprises:
a two-dimensional arrangement information input part which inputs two-dimensional arrangement information representing a two-dimensional arrangement of the step; and
a depth information input part which inputs depth information representing a depth of the step.

19. The coating apparatus according to claim 18, wherein said two-dimensional arrangement information input part includes an image information acquiring portion which acquires image information of the substrate held by said holding section.

20. A coating method, comprising:
a first coating step of applying a first liquid on a substrate having a step on a major surface, according to an arrangement of the step; and
a second coating step of applying, according to the arrangement of the step, a second liquid different in viscosity from the first liquid on the substrate on which the first liquid is applied in said first step.

21. The coating method according to claim 20, wherein the first liquid is higher in viscosity than the second liquid.

22. The coating method according to claim 20, further comprising a coated area determining step of determining areas to be coated on which the respective first and second liquids are to be applied in said first and second steps respectively.

23. The coating method according to claim 20 further comprising, between said first and second coating steps, a drying step of drying the first liquid applied on the substrate in said first coating step.

24. A coating apparatus, comprising:
a substrate holding section which holds a substrate having a step on a major surface;
a coating section which applies a plurality of liquids different in viscosity from each other on the substrate; and
a control section which controls a kind and an application amount of the liquid to be applied by said coating section according to an arrangement of the step.

25. A coating method, comprising:
a first coating step of applying a first liquid on a substrate having a step on a major surface according to an arrangement of the step, the applied first liquid being thinner than a depth of the step; and
a second coating step of applying a second liquid different in viscosity from the first liquid on the substrate on which the first liquid is applied in said first step.
